(19) United States
(12) Patent Application Publication
(10) Pub. No.: US 2011/0266705 A1
(43) Pub. Date: Nov. 3, 2011

(54) TEMPLATE REPAIR METHOD, PATTERN FORMING METHOD, AND TEMPLATE REPAIR APPARATUS

(76) Inventors: Shinichi ITO, Yokohama-Shi (JP); Takuya KONO, Yokosuka-Shi (JP)

(21) Appl. No.: 13/069,186

(22) Filed: Mar. 22, 2011

(30) Foreign Application Priority Data
Apr. 28, 2010 (JP) 2010-104564

(51) Int. Cl. B29C 33/38; B05C 3/02; B28B 7/38

(52) U.S. Cl. 264/39; 427/133; 118/72; 118/400

(57) ABSTRACT

A template repair method according to one embodiment is a method for repairing a template including a template base material and a first mold release layer formed on a pattern surface of the template base material, and a restorative material is supplied to the pattern surface of the template base material in the template repair method. The restorative material has affinity to the base material and non-affinity to the mold release layer.

### CROSS REFERENCE TO RELATED APPLICATIONS

This application is based upon and claims the benefit of priority from the prior Japanese Patent Application No. 2010-104564, filed on Apr. 28, 2010, the entire contents of which are incorporated herein by reference.

### FIELD

Embodiments described herein relate generally to a template repair method, a pattern forming method, and a template repair apparatus.

### BACKGROUND

A nanoimprint method is a technology of transferring a concave-convex pattern formed on a template (also called an original plate, a stamper, or a mold) to an imprint material on a processed film. When an imprint is performed while a micro particle exists on a template surface or a processed film surface, the micro/nano particle damages the template and generates a defect in the template surface. Because the defect is also transferred to an imprint material when the defect exists on the template surface, there is a demand for a defect-free template.

### BRIEF DESCRIPTION OF THE DRAWINGS

FIG. 1A and 1B are sectional views illustrating an example of a template;

FIG. 2 is a block diagram illustrating an example of a schematic configuration of a template repair apparatus according to a first embodiment of present the invention;

FIGS. 3A, 3B, 3C, and 3D are main-part sectional views illustrating a state in which a defective portion is repaired in the template of the first embodiment;

FIG. 4 is a flowchart illustrating an example of a process of repairing the defective portion in the template of the first embodiment;

FIG. 5 is a block diagram illustrating an example of a schematic configuration of a template repair apparatus according to a second embodiment of the present invention;

FIGS. 6A, 6B, 6C, 6D, and 6E are main-part sectional views illustrating a state in which a defective portion is repaired in the template of the second embodiment;

FIG. 7 is a flowchart illustrating an example of a process of repairing the defective portion in the template of the second embodiment;

FIG. 8 is a block diagram illustrating an example of a schematic configuration of a template repair apparatus according to a third embodiment of the present invention;

FIGS. 9A, 9B, 9C, 9D, 9E, and 9F are main-part sectional views illustrating a state in which a defective portion is repaired in the template of the third embodiment;

FIG. 10 is a flowchart illustrating an example of a process of repairing the defective portion in the template of the third embodiment;

FIG. 11 is a block diagram illustrating an example of a schematic configuration of a template repair apparatus according to a fourth embodiment of the present invention;

FIGS. 12A, 12B, 12C, 12D, 12E, 12F, and 12G are main-part sectional views illustrating a state in which a defective portion is repaired in the template of the fourth embodiment;

FIG. 13 is a flowchart illustrating an example of a process of repairing the defective portion in the template of the fourth embodiment;

FIG. 14 is a block diagram illustrating an example of a schematic configuration of an imprint apparatus according to a fifth embodiment of the present invention;

FIG. 15 is a diagram illustrating an example of a schematic configuration of an imprint apparatus according to a modification of the fifth embodiment; and

FIG. 16 is a diagram illustrating an example of a schematic configuration of an imprint apparatus according to a sixth embodiment of the present invention.

### DETAILED DESCRIPTION

Hereafter, a template repair method, a pattern forming method, a template repair apparatus according to the present invention will be described more specifically with reference to the drawings.

A template repair method according to one embodiment is a method for repairing a template including a template base material and a first mold release layer formed on a pattern surface of the template base material, and a restorative material is supplied to the pattern surface of the template base material in the template repair method. The restorative material has affinity to the base material and non-affinity to the mold release layer.

### (Configuration of Template)

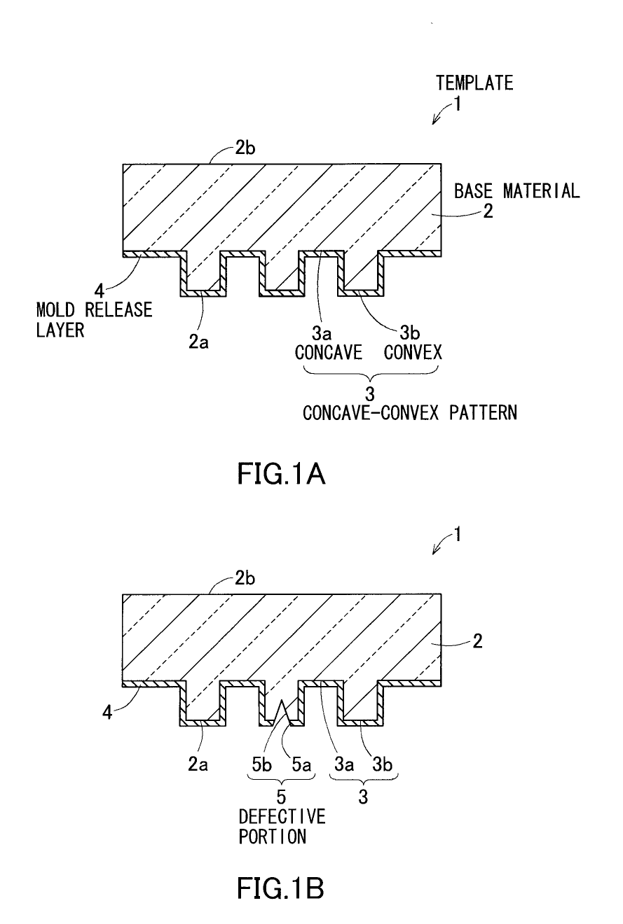

FIG. 1A is a sectional view illustrating an example of a template, and FIG. 1B is a sectional view illustrating a state in which a defect is generated in the template of FIG. 1A.

As illustrated in FIG. 1A, a template 1 includes a base material 2 and a mold release layer (first mold release layer) 4. The base material 2 includes a first and second principal surfaces 2a and 2b that are opposite each other, and a concave-convex pattern 3 including concave shape 3a and convex shape 3b is formed on the first principal surface 2a. The mold release layer 4 is formed on a surface of the concave-convex pattern 3.

The concave-convex pattern 3 of the base material 2 includes, for example, periodic line and space patterns of less than 100 nm pitch. For example, the base material 2 is made of quartz having light transparency.

A material that improves a mold release property with respect to an imprint material is used to form the mold release layer 4. For example, a silane coupling agent such as hexamethyldisilazane and/or a fluorine-based material such as fluorohydrocarbon can be used when an organic material is used as the imprint material. The fluorohydrocarbon is used in the embodiments herein. The mold release layer 4 has a thickness of, for example, about 1 nm. As used herein, the “mold release property” means a property in separating (releasing) the imprint material from the template after curing the imprint material. The improvement of the mold release property can release the pattern of the cured imprint material with no damage.

### (Use of Template)

The template 1 is used, for example, in the following nanoimprint method. That is, the imprint material made of a photo-curing resin is applied onto the processed film formed on a substrate, and the imprint material is irradiated with an ultraviolet ray from a side of the second principal surface 2b of the template 1 while the first principal surface 2a is brought into contact with the imprint material, thereby curing the imprint material. Then the concave-convex pattern 3 of the template 1 is transferred as the convex-concave pattern to the imprint material on the processed film while the template 1 is released from the cured imprint material. The processed firm is etched by RIE (Reactive Ion Etching) with the concave-convex imprint material to which the concave-convex pattern 3 is transferred as a mask. Alternatively, a thermoplastic resin or a thermal curing resin may be used as the imprint material.

When the template 1 is repeatedly used, sometimes a fine defective portion 5 is generated in the concave-convex pattern 3 as illustrated in FIG. 1B. For example, the defective portion 5 includes a defective portion 5a in which the mold release layer 4 is lost and a recessed defective portion 5b in which the base material 2 is gouged. The defective portion 5 is formed on a bottom surface or a side face of the concave shape 3a or the convex shape 3b. The defective portion 5 can be repaired by a template repair apparatus described below.

### First Embodiment

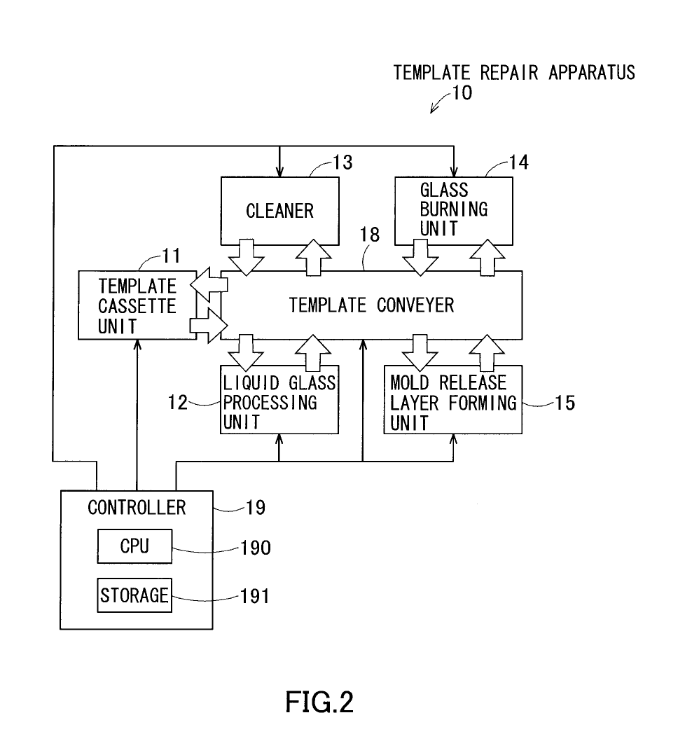

FIG. 2 is a block diagram illustrating an example of a schematic configuration of a template repair apparatus according to a first embodiment of the present invention.

A template repair apparatus 10 repairs the template 1 having the defective portion 5 as illustrated in FIG. 1B. The template repair apparatus 10 includes a template cassette unit 11, a liquid glass processing unit 12, a cleaner 13, a glass burning unit 14, a mold release layer forming unit 15, a template conveyer 18, and a controller 19.

The template cassette unit 11 includes a template cassette on which the template 1 is set.

The liquid glass processing unit 12 includes a glassy solution tank in which a glassy solution for repairing the defective portion 5b of the base material 2 is stored. The liquid glass processing unit 12 is configured such that the surface of the concave-convex pattern 3 of the template 1 can be dipped in a glassy solution of the glassy solution tank. The glassy solution is a solution containing a glass component.

The cleaner 13 includes a cleaning solution tank in which a cleaning solution is stored. The glassy solution having adhered to the mold release layer 4 except the defective portion 5 of the template 1 is cleaned and removed by dipping the surface of the concave-convex pattern 3 of the template 1 in the cleaning solution in the cleaning solution tank. The liquid glass processing unit 12 may include the cleaner 13.

The glass burning unit 14 includes heating means for solidifying the glassy solution having adhered to the defective portion 5b of the template 1. For example, a heater or an infrared lamp can be used as the heating means.

The mold release layer forming unit 15 includes a mold release material solution tank in which a solution containing a mold release material is stored. The mold release layer forming unit 15 is configured such that the surface of the concave-convex pattern 3 of the template 1 can be dipped in the solution in the mold release material solution tank. The mold release layer forming unit 15 may include the cleaner 13.

The template conveyer 18 conveys the template 1 among the template cassette unit 11, the liquid glass processing unit 12, the cleaner 13, the glass burning unit 14, and the mold release layer forming unit 15.

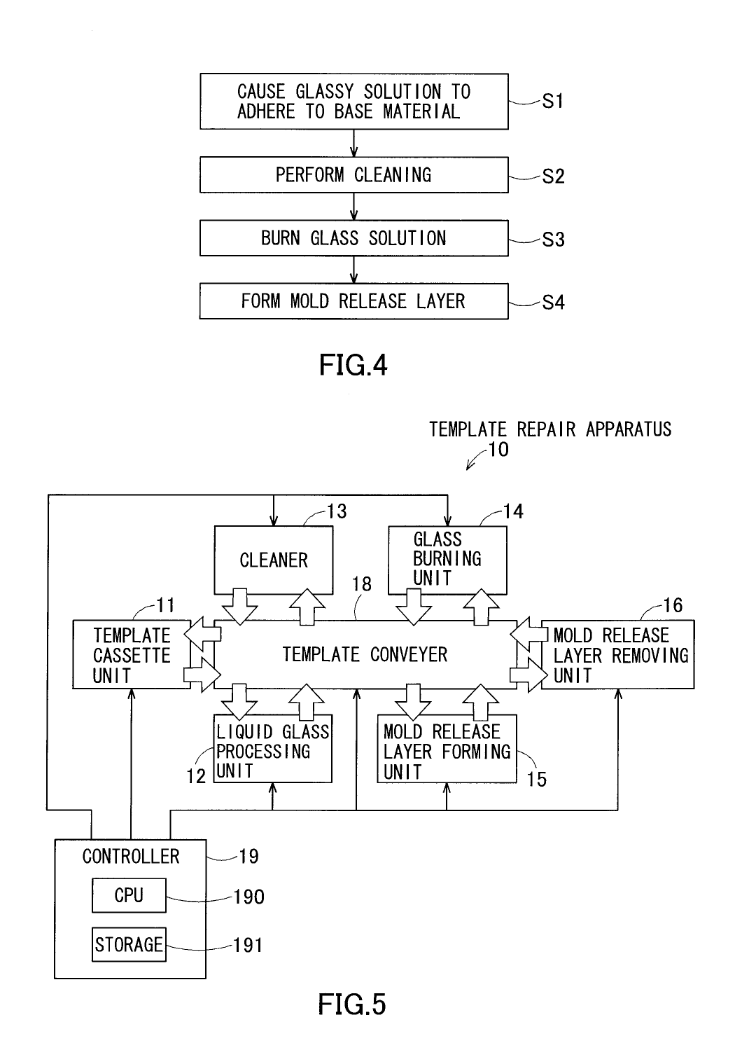

The controller 19 includes a CPU 190 and a storage 191 such as a semiconductor memory in which a program illustrated in FIG. 4 and the like is stored. The CPU 190 operates according to the program stored in the storage 191. The CPU 190 repairs the template 1 by controlling the template cassette unit 11, the liquid glass processing unit 12, the cleaner 13, the glass burning unit 14, the mold release layer forming unit 15, and the template conveyer 18.

### (Operation of First Embodiment)

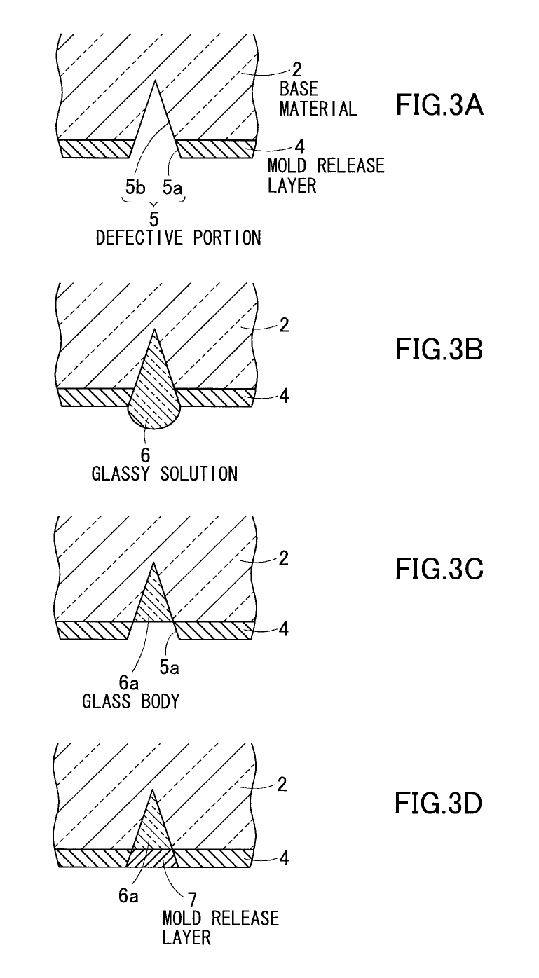

An operation of the template repair apparatus 10 of the first embodiment will now be described below, with reference to FIGS. 1 to 4. FIGS. 3A to 3D are main-part sectional views illustrating a state in which the defective portion is repaired in the template of the first embodiment. FIG. 4 is a flowchart illustrating an example of a process of repairing the defective portion in the template of the first embodiment.

The template 1 is set on the template cassette of the template cassette unit 11 at a predetermined timing. Although the predetermined timing can appropriately be set, the predetermined timing may be set to the time at which the defective portion is predicted to be generated on the surface of the concave-convex pattern 3 of the template 1. For example, the predetermined timing is managed by the number of pattern forming times with the template 1 or the number of processed wafers. Specifically, the predetermined timing can be set in each several shots, each several wafers, or each several lots. As illustrated in FIG. 3A, in the defective portion 5 of the template 1, the mold release layer 4 is peeled off and the base material 2 is gouged. In the repair process, an inspection for the presence or free of the defect is not required. Alternatively, the presence or free of the defect may be inspected to determine whether the repair process is required.

### (1) Glassy Solution Adhesion Process

The controller 19 takes out the template 1 from the template cassette unit 11 to cause the template conveyer 18 to convey the template 1 to the liquid glass processing unit 12.

The liquid glass processing unit 12 dips the surface of the concave-convex pattern 3 of the template 1 in the glassy solution 6. As illustrated in FIG. 3B, the glassy solution 6 selectively deposites in the defective portion 5a of the base material 2, and the glassy solution 6 adheres to the quartz due to a reaction between the quartz that is of the material for the base material 2 and a glass component of the glassy solution 6 or due to an intermolecular force between the quartz and the glass component (S1).

The glassy solution 6 has the affinity to the quartz that is of the material for the base material 2, and has the non-affinity to the fluorohydrocarbon that is of the material for the mold release layer 4. A solution containing silicon oxide which includes no organic group such as a methyl group but only a siloxane structure, for example, a silicon oxide supersaturated solution of a hydrofluoric acid, is used as the glassy solution 6 so as to have the non-affinity to the fluorohydrocarbon that is of the material for the mold release layer 4. When the silicon oxide supersaturated solution of the hydrofluoric acid is caused to adhere to the quartz, the siloxane structure is formed and organized in the defective portion in which the quartz is exposed. As used herein, the “non-affinity” means that the affinity is relatively low with respect to the base material 2. As to a method for determining the affinity, for example, the determination can be made by contact angles of the glassy solution 6 to the base material 2 and the material for the mold release layer 4. Accordingly, in the first embodiment, the contact angle of the glassy solution 6 to the base material 2 is smaller than that of the glassy solution 6 to the material of the mold release layer 4.

As to the adhesion method for the glassy solution 6, for example, a method of applying the glassy solution 6, a method of bringing the glassy solution 6 into contact with the base material 2, and a method of adsorbing the glassy solution 6 by utilizing capillarity can be used in addition to the dipping.

When the adhesion method for the glassy solution 6 is ended, the controller 19 causes the template conveyer 18 to convey the template 1 to the cleaner 13.

### (2) Cleaning Process

The cleaner 13 dips the surface of the concave-convex pattern 3 of the template 1 in the cleaning solution. The glassy solution 6 having adhered to the mold release layer 4 except the defective portion 5 is cleaned and removed by the cleaning solution (S2). On the other hand, the glassy solution 6 having deposited in the defective portion 5a is not removed by the cleaning solution because the glassy solution 6 is organized with the base material 2. Therefore, the glassy solution 6 can selectively adhere to the surface of the concave-convex pattern 3 of the template 1. For example, a thinner for the glassy solution is used as the cleaning solution. Specifically, a dilute hydrofluoric acid is used as the cleaning solution. Alternatively, the cleaning may be performed after a process of burning the glassy solution 6. The cleaning process may be omitted when the glass has not adhered to the mold release layer 4 except the defective portion 5.

When the cleaning process is ended, the controller 19 causes the template conveyer 18 to convey the template 1 to the glass burning unit 14.

### (3) Glassy Solution Burning Process

As illustrated in FIG. 3C, the glass burning unit 14 solidifies the organized glassy solution 6 of the template 1 by burning the organized glassy solution 6 at 150° C. to 250° C., thereby forming a glass body 6a fixed strongly to the base material 2 (S3). When the glassy solution 6 is solidified and shrunk through the burning process, possibly the surface of the solidified glassy solution 6 (glass body 6a) does not reach the surface of the concave-convex pattern 3 of the template 1. In such cases, the organization in which the glassy solution 6 is used and the burning process may repeatedly be performed to adjust a position of the surface of the glass body 6a.

When the burning process is ended, the controller 19 causes the template conveyer 18 to convey the template 1 to the mold release layer forming unit 15.

### (4) Mold Release Material Adhesion Process

As illustrated in FIG. 3D, the mold release layer forming unit 15 dips the surface of the concave-convex pattern 3 of the template 1 in the solution. When the glass body 6a of the template 1 is exposed to an atmosphere, the glass body 6a reacts with water molecules in air to cover the surface of the glass body 6a with OH groups. Accordingly, when a material having a region reacting with the OH group at a tail end is used as the mold release material, the mold release material reacts with the OH group to couple to the glass body 6a, and the mold release layer (second mold release layer) 7 is formed on the surface of the glass body 6a (S4). An area where the mold release layer 4 has been already formed has hydrophobicity not to react with the mold release material, so that the mold release layer 7 can selectively be formed on the surface of the glass body 6a.

For example, silazane compounds such as hexamethyldisilazane and/or tetramethyldisilazane, a fluorine-containing silazane compound, and/or a silane coupling agent such as fluorocarbon can be used as the mold release material. The mold release layer (second mold release layer) 7 formed on the surface of the glass body 6a may be made of a material different from that of the mold release layer (first mold release layer) 4 except the surface of the glass body 6a. However, when a partial difference of the mold release property (mold release force) exists in the imprint material, a defect such as peel-off or cutting of the imprint pattern is generated in the portion in which the partial difference exists. Therefore, the mold release material having the mold release property (mold release force), with respect to the imprint material, which is equal to that of the mold release layer 4 is desirably used.

As to the mold release material adhesion method, for example, a method of applying a solution containing the mold release material, a method of bringing the solution into contact with the surface of the glass body 6a, and a method of causing the mold release material to selectively react with the surface of the glass body 6a in a gaseous phase by CVD (Chemical Vapor Deposition) or using an N₂ gas in which the mold release material is contained by bubbling the mold release material with N₂ can be used in addition to the dipping.

### Second Embodiment

FIG. 5 is a block diagram illustrating an example of a schematic configuration of a template repair apparatus according to a second embodiment of the present invention. In the second embodiment, instead of the mold release material adhesion process of the first embodiment, the mold release layer 7 is removed to newly form the mold release layer 4 in the whole surface of the concave-convex pattern 3 of the template 1. Hereinafter, the constituent having the function similar to that of the first embodiment is designated by the identical reference numeral, and the description will not be repeated.

In the template repair apparatus 10 of the second embodiment, a mold release layer removing unit 16 is added to the template repair apparatus 10 of FIG. 2. However, similarly to the first embodiment, the template repair apparatus 10 of the second embodiment includes the template cassette unit 11, the liquid glass processing unit 12, the cleaner 13, the glass burning unit 14, the mold release layer forming unit 15, the template conveyer 18, and the controller 19.

The template conveyer 18 conveys the template 1 among the template cassette unit 11, the liquid glass processing unit 12, the cleaner 13, the glass burning unit 14, the mold release layer forming unit 15, and the mold release layer removing unit 16.

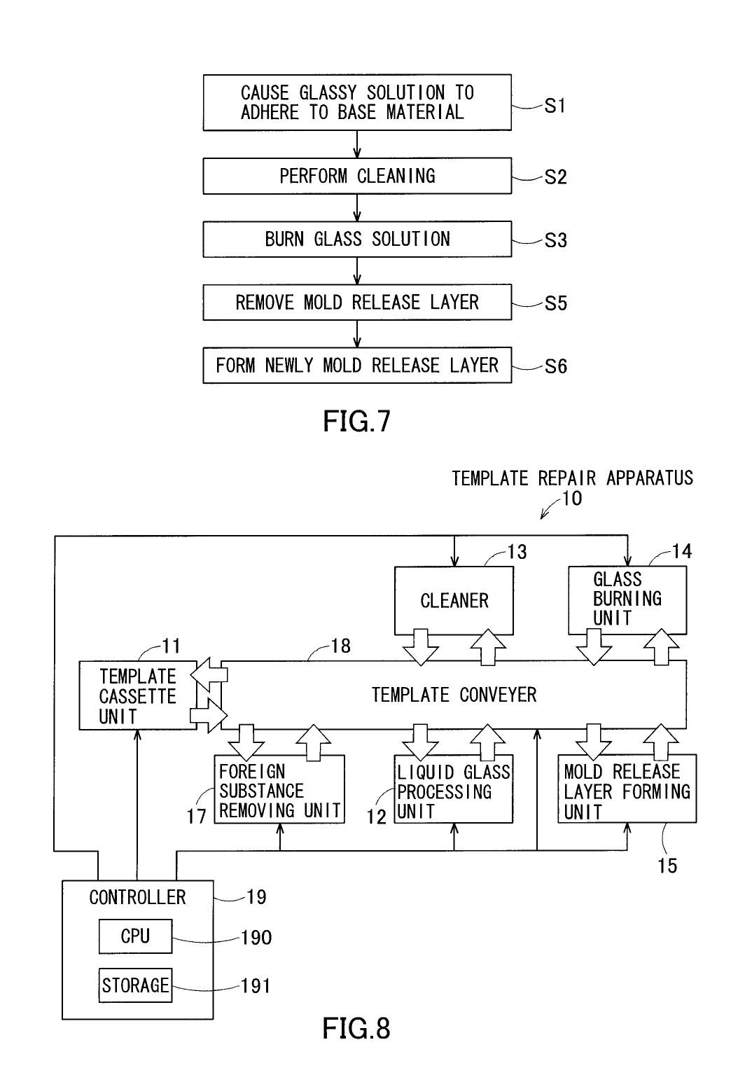

The controller 19 includes the CPU 190 and the storage 191 such as the semiconductor memory in which a program illustrated in FIG. 7 and the like is stored. In response to a repair start instruction from an operator, the CPU 190 operates according to the program stored in the storage 191, and the CPU 190 repairs the template 1 by controlling the template cassette unit 11, the liquid glass processing unit 12, the cleaner 13, the glass burning unit 14, the mold release layer forming unit 15, the mold release layer removing unit 16, and the template conveyer 18.

The mold release layer removing unit 16 includes a removal mechanism that removes the mold release layer 4. The mold release layer removing unit 16 can remove the mold release layer 4, formed on the surface of the concave-convex pattern 3 of the template 1, to expose the base material 2 of the surface of the concave-convex pattern 3. For example, the mold release layer removing unit 16 includes a mold release layer removal mechanism that can remove the mold release layer 4 while gas is supplied or a mold release layer removal mechanism that can supply a dissolving solution to remove the mold release layer 4. For example, when a fluorine-based material is used as the mold release layer 4, a fluorine-ion-containing solution such as a hydrofluoric acid water solution, an ammonium fluoride water solution, and a mixture thereof can be used as the dissolving solution. When a silane-containing material is used as the mold release layer 4, the mold release layer 4 can be removed by plasma containing fluorine. When a carbon-containing material is used as the mold release layer 4, the mold release layer 4 is irradiated with an ultraviolet ray while O₃ is supplied, which allows the mold release layer 4 to be removed.

### (Operation of Second Embodiment)

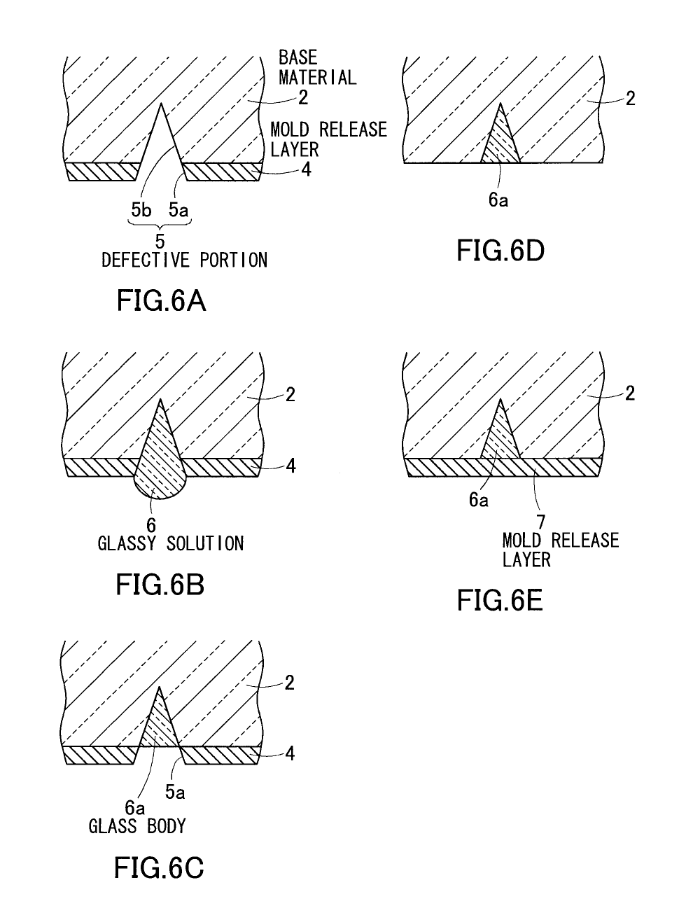

An operation of the template repair apparatus 10 of the second embodiment will now be described below with reference to FIGS. 5 to 7. FIGS. 6A to 6E are main-part sectional views illustrating a state in which a defective portion is repaired in the template of the second embodiment. FIG. 7 is a flowchart illustrating an example of a process of repairing the defective portion in the template of the second embodiment. The operation of the second embodiment will be described mainly on differences from the first embodiment.

Similarly to the first embodiment, after the surface of the concave-convex pattern 3 of the template 1 is dipped in the glassy solution 6 (S1), the glassy solution having adhered to the mold release layer 4 except the defective portion 5 is cleaned by the cleaning solution (S2), and the glassy solution 6 is burned to form the glass body 6a (S3).

Sometimes the mold release layer 4 is degraded or the glass having adhered to the mold release layer 4 cannot be cleaned by the cleaning. In such cases, in the second embodiment, the mold release layer 4 is removed as follows (S5).

When the burning process is ended, the controller 19 causes the template conveyer 18 to convey the template 1 to the mold release layer removing unit 16.

The mold release layer removing unit 16 places the surface of the concave-convex pattern 3 of the template 1 in the mold release layer removal mechanism to remove the mold release layer 4 (S5).

When the mold release layer removing process is ended, the controller 19 causes the template conveyer 18 to convey the template 1 to the mold release layer forming unit 15.

The mold release layer forming unit 15 dips the surface of the concave-convex pattern 3 of the template 1 in the solution in the mold release material solution tank to newly form the mold release layer (second mold release layer) 7 on the surface of the concave-convex pattern 3 (S6). In the second embodiment, after the whole mold release layer 4 is removed, the mold release layer 7 is formed on the whole surface of the concave-convex pattern 3 of the template 1. Therefore, the process of removing the mold release layer 4, having been degraded after several cycles of the imprint process, to form the mold release layer 4 again and the mold release layer forming process performed in the repair portion after the process of repairing the template 1 can collectively be performed. Even if the glassy solution 6 adheres to the surface of the mold release layer 4, a foreign substance can be suppressed on the surface of the concave-convex pattern 3 because the glassy solution 6 having adhered to the surface of the mold release layer 4 is simultaneously removed by entirely removing the mold release layer 4 once.

### Third Embodiment

FIG. 8 is a block diagram illustrating an example of a schematic configuration of a template repair apparatus according to a third embodiment of the present invention. In the first and second embodiments, no foreign substance exists in the defective portion 5. On the other hand, in the third embodiment, a pre-process is performed to remove the foreign substance when the foreign substance exists in the defective portion 5. Hereinafter, the constituent having the function similar to that of the first embodiment is designated by the identical reference numeral, and the description will not be repeated.

In the template repair apparatus 10 of the third embodiment, a foreign substance removing unit 17 is added to the template repair apparatus 10 of FIG. 2. However, similarly to the first embodiment, the template repair apparatus 10 of the third embodiment includes the template cassette unit 11, the liquid glass processing unit 12, the cleaner 13, the glass burning unit 14, the mold release layer forming unit 15, the template conveyer 18, and the controller 19.

The template conveyer 18 conveys the template 1 among the template cassette unit 11, the liquid glass processing unit 12, the cleaner 13, the glass burning unit 14, the mold release layer forming unit 15, and the foreign substance removing unit 17.

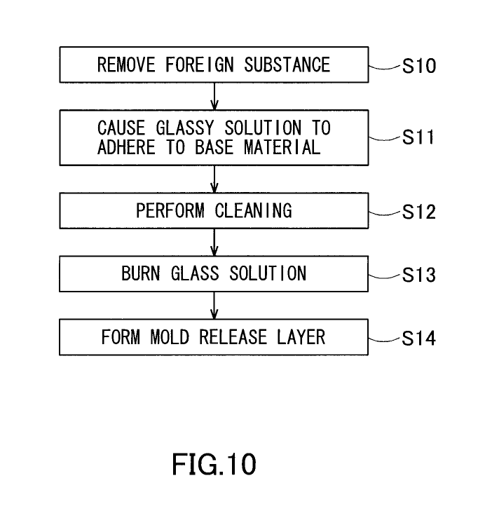

The controller 19 includes the CPU 190 and the storage 191 such as the semiconductor memory in which a program illustrated in FIG. 10 and the like is stored. The CPU 190 operates according to the program stored in the storage 191, and the CPU 190 repairs the template 1 by controlling the template cassette unit 11, the liquid glass processing unit 12, the cleaner 13, the glass burning unit 14, the mold release layer forming unit 15, the foreign substance removing unit 17, and the template conveyer 18.

The foreign substance removing unit 17 includes an etching solution tank and a cleaner by cleaning agent. An etching solution (corrosive substance) for etching the quartz that is of the material for the base material 2 is stored in the etching solution tank. The water cleaner cleans the surface of the template 1, processed by the etching solution, using water. The foreign substance removing unit 17 is configured such that the surface of the concave-convex pattern 3 of the template 1 can be dipped in the etching solution in the etching solution tank. The base material 2 is etched by dipping the surface of the concave-convex pattern 3 of the template 1 in the etching solution, which allows the removal of the foreign substance having invaded in the defect portion 5. In the third embodiment, for example, hydrogen fluoride (hydrofluoric acid) or an ammonium fluoride solution is used as the etching solution. The foreign substance having invaded in the defect portion 5 can be removed by etching the base material 2.

A process of removing only the foreign substance may be performed. For example, an oxidizing process, such as an ozone process irradiation of UV (ultraviolet) light and a process with mixture of hydrogen peroxide water and sulfuric acid, can be used when a resist and the like of the imprint material remains as the foreign substance in the defective portion 5. When the foreign substance is made of metal, the foreign substance may be removed by acid or alkali that dissolves the metal without damaging the base material 2 and the mold release layer 4.

### (Operation of Third Embodiment)

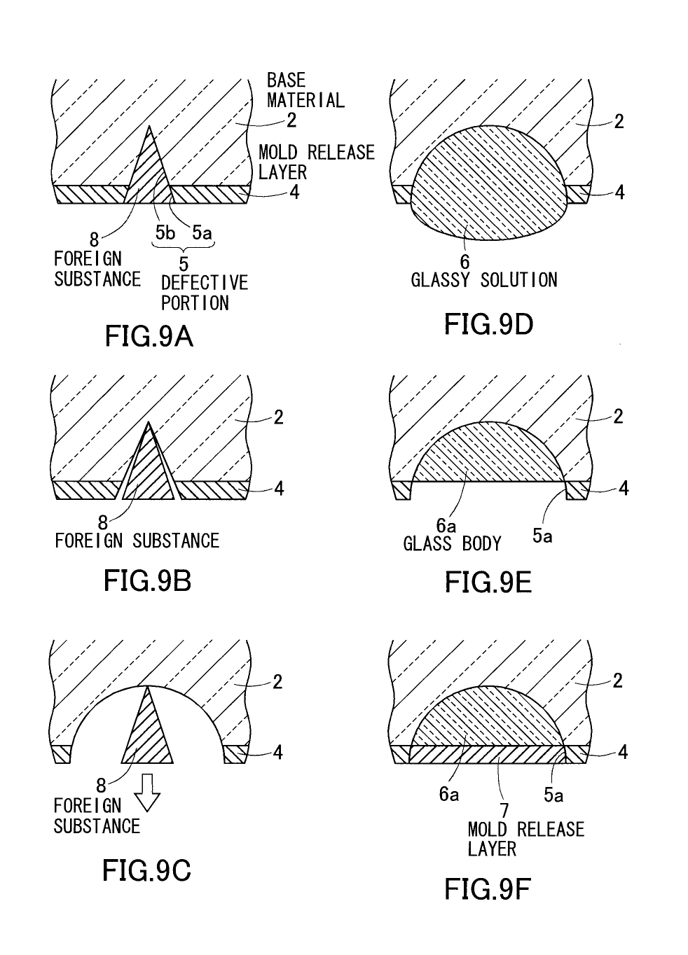

An operation of the template repair apparatus 10 of the third embodiment will now be described below with reference to FIGS. 8 to 10. FIGS. 9A to 9F are main-part sectional views illustrating a state in which a defective portion is repaired in the template of the third embodiment. FIG. 10 is a flowchart illustrating an example of a process of repairing the defective portion in the template of the third embodiment. The operation of the third embodiment will be described mainly on differences from the first embodiment. It is assumed that the mold release layer 4 of the template 1 of the third embodiment is formed as a trimethylsilane layer by coupling hexamethyldisilazane.

First, the template 1 is set on the template cassette of the template cassette unit 11 at a predetermined timing.

### (1) Foreign Substance Removing Process

The controller 19 takes out the template 1 from the template cassette unit 11 to cause the template conveyer 18 to convey the template 1 to the foreign substance removing unit 17.

The foreign substance removing unit 17 dips the surface of the concave-convex pattern 3 of the template 1 in the etching solution in the etching solution tank. The imprint material of a foreign substance 8 does not react with the hydrofluoric acid. In the portion in which the mold release layer 4 is formed, invasion of the hydrofluoric acid is suppressed to prevent the hydrofluoric acid from corroding the quartz of the base material 2. As illustrated in FIG. 9B, the etching solution penetrates between the foreign substance 8 and the base material 2 to corrode the quartz of the base material 2. As illustrated in FIG. 9C, the foreign substance 8 is discharged from the defective portion 5 of the quartz at a stage at which the quartz around the imprint material buried in the defective portion 5 is dissolved (S10).

Then, the foreign substance removing unit 17 cleans the template 1 to remove the hydrofluoric acid remaining in the surface of the template 1 using the water cleaner.

When the foreign substance removing process is ended, the controller 19 causes the template conveyer 18 to convey the template 1 to the liquid glass processing unit 12.

### (2) Glassy Solution Adhesion Process

Similarly to the first embodiment, the liquid glass processing unit 12 dips the surface of the concave-convex pattern 3 of the template 1 in the glassy solution 6 in the glassy solution tank. As illustrated in FIG. 9D, the glassy solution 6 invades in the defective portion 5b of the base material 2, and the glassy solution 6 adheres to the quartz due to the reaction between the quartz that is of the material for the base material 2 and the glass component or the intermolecular force between the quartz and the glass component (S11).

The glassy solution 6 has the affinity to the quartz that is of the material for the base material 2, and has the non-affinity to the trimethylsilane that is of the material for the mold release layer 4. The solution containing silicon oxide which includes not the organic group such as the methyl group but only the siloxane structure, for example, the silicon oxide supersaturated solution of the hydrofluoric acid is used as the glassy solution 6 so as to have the non-affinity to the trimethylsilane that is of the material for the mold release layer 4. When the silicon oxide supersaturated solution of the hydrofluoric acid is caused to adhere to the quartz, the siloxane structure is formed and organized in the defective portion in which the quartz is exposed.

As to the adhesion method for the glassy solution 6, for example, the method of applying the glassy solution 6, the method of bringing the glassy solution 6 into contact with the base material 2, and the method of adsorbing the glassy solution 6 by utilizing capillarity can be used in addition to the dipping.

When the adhesion method for the glassy solution 6 is ended, the controller 19 causes the template conveyer 18 to convey the template 1 to the cleaner 13.

### (3) Cleaning Process

The cleaner 13 dips the surface of the concave-convex pattern 3 of the template 1 in the cleaning solution in the cleaning solution tank. The glassy solution 6 having adhered to the mold release layer 4 except the defective portion 5 is cleaned and removed by the cleaning solution (S12).

When the cleaning process is ended, the controller 19 causes the template conveyer 18 to convey the template 1 to the glass burning unit 14.

### (4) Glassy Solution Burning Process

As illustrated in FIG. 9E, the glass burning unit 14 solidifies the organized glassy solution 6 of the template 1 by burning the organized glassy solution 6 at 150° C. to 250° C., thereby forming a glass body 6a fixed strongly to the base material 2 (S13).

When the burning process is ended, the controller 19 causes the template conveyer 18 to convey the template 1 to the mold release layer forming unit 15.

### (5) Mold Release Material Adhesion

As illustrated in FIG. 9E, the mold release layer forming unit 15 dips the surface of the concave-convex pattern 3 of the template 1 in the solution containing the mold release material. When the glass body 6a of the template 1 is exposed to an atmosphere, the glass body 6a reacts with water molecules in air to cover the surface of the glass body 6a with OH groups. Accordingly, similarly to the first embodiment, when the material having the region reacting with the OH group at the tail end is used as the mold release material, the mold release material reacts with the OH group to couple to the glass body 6a (S14). In the third embodiment, even if the foreign substance exists in the defective portion 5, the template 1 can be repaired after the foreign substance is removed.

### Fourth Embodiment

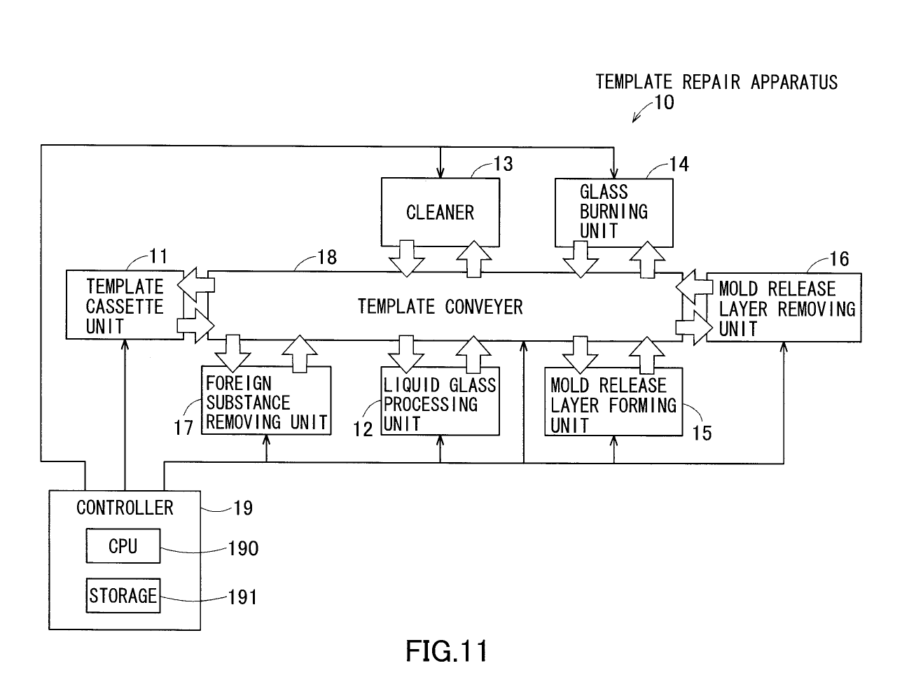

FIG. 11 is a block diagram illustrating an example of a schematic configuration of a template repair apparatus according to a fourth embodiment of the present invention. In the fourth embodiment, instead of the mold release material adhesion process of the third embodiment, the mold release layer (first mold release layer) 4 is removed to newly form the mold release layer (second mold release layer) 7. Hereinafter, the constituent having the function similar to that of the third embodiment is designated by the identical reference numeral, and the description will not be repeated.

In the template repair apparatus 10 of the fourth embodiment, the mold release layer removing unit 16 is added to the template repair apparatus 10 of FIG. 8. However, similarly to the third embodiment, the template repair apparatus 10 of the fourth embodiment includes the template cassette unit 11, the liquid glass processing unit 12, the cleaner 13, the glass burning unit 14, the mold release layer forming unit 15, the foreign substance removing unit 17, the template conveyer 18, and the controller 19.

The template conveyer 18 conveys the template 1 among the template cassette unit 11, the liquid glass processing unit 12, the cleaner 13, the glass burning unit 14, the mold release layer forming unit 15, the mold release layer removing unit 16, and the foreign substance removing unit 17.

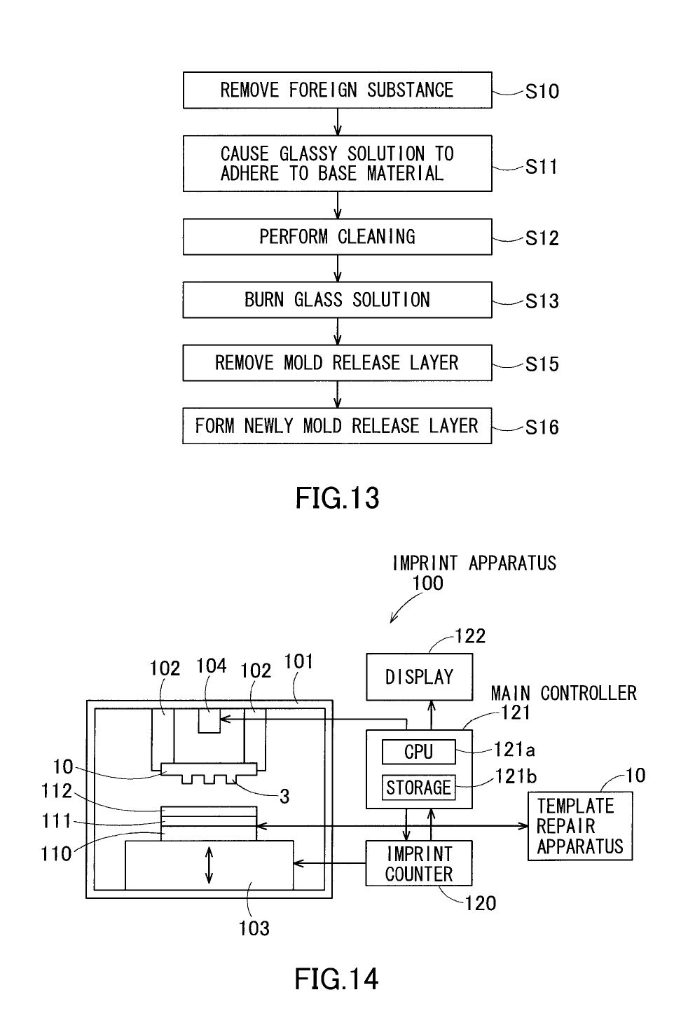

The controller 19 includes the CPU 190 and the storage 191 such as the semiconductor memory in which a program illustrated in FIG. 13 and the like is stored. The CPU 190 operates according to the program stored in the storage 191, and the CPU 190 repairs the template 1 by controlling the template cassette unit 11, the liquid glass processing unit 12, the cleaner 13, the glass burning unit 14, the mold release layer forming unit 15, the mold release layer removing unit 16, the foreign substance removing unit 17, and the template conveyer 18.

### (Operation of Fourth Embodiment)

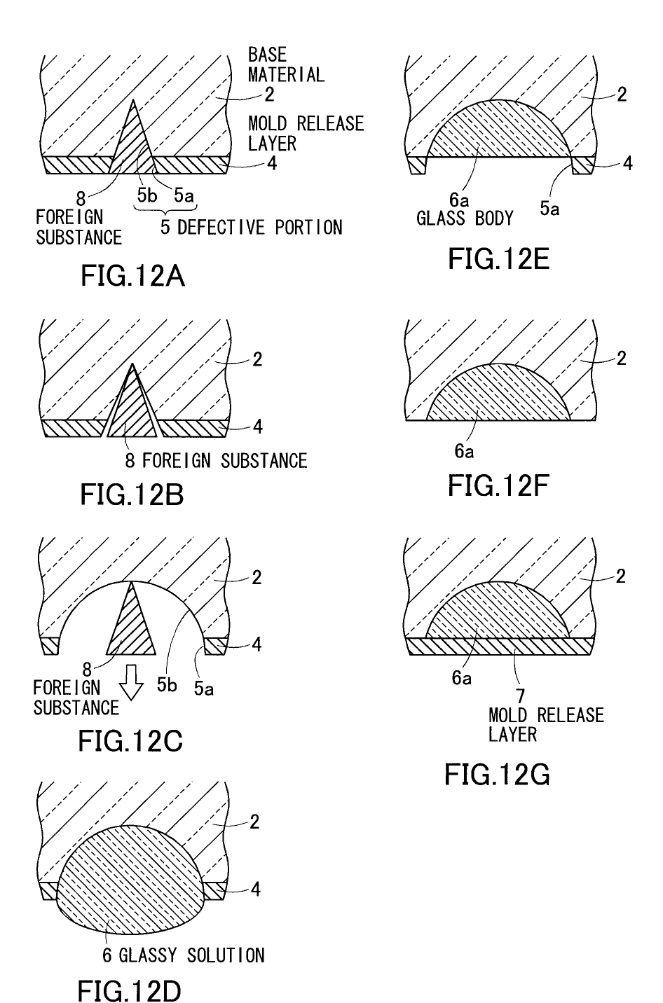

An operation of the template repair apparatus 10 of the fourth embodiment will now be described below with reference to FIGS. 11 to 13. FIGS. 12A to 12G are main-part sectional views illustrating a state in which a defective portion is repaired in the template of the fourth embodiment. FIG. 13 is a flowchart illustrating an example of a process of repairing the defective portion in the template of the fourth embodiment. The operation of the fourth embodiment will be described mainly on differences from the third embodiment.

Similarly to the third embodiment, the foreign substance 8 is removed as illustrated in FIGS. 12A to 12C (S10), and the surface of the concave-convex pattern 3 of the template 1 is dipped in the glassy solution 6 as illustrated in FIG. 12D (S11). Then, the glassy solution having adhered to the mold release layer 4 except the defective portion 5 is cleaned by the cleaning solution (S12), and the glassy solution 6 is burned to form the glass body 6a as illustrated in FIG. 12E (S13).

Sometimes the mold release layer 4 is degraded or the glass having adhered to the mold release layer 4 cannot be cleaned by the cleaning. In such cases, in the fourth embodiment, the mold release layer 4 is removed as follows (S15).

When the burning process is ended, the controller 19 causes the template conveyer 18 to convey the template 1 to the mold release layer removing unit 16.

As illustrated in FIG. 12F, the mold release layer removing unit 16 removes the mold release layer 4 formed on the whole surface of the concave-convex pattern 3 of the template 1 (S15).

When the mold release layer removing process is ended, the controller 19 causes the template conveyer 18 to convey the template 1 to the mold release layer forming unit 15.

The mold release layer forming unit 15 dips the surface of the concave-convex pattern 3 of the template 1 in the mold release material solution in the mold release material solution tank to newly forms the mold release layer 7 on the surface of the concave-convex pattern 3 (S16).

### Fifth Embodiment

FIG. 14 is a block diagram illustrating an example of a schematic configuration of an imprint apparatus according to a fifth embodiment of the present invention.

An imprint apparatus 100 includes the template repair apparatus 10 of the first, second, third, or fourth embodiment. The imprint apparatus 100 includes a chamber 101. A retaining member 102, a pressurizing stage 103, and a light source 104 are disposed in the chamber 101. The retaining member 102 retains the template 1. The pressurizing stage 103 elevates a substrate 110, made of silicon or the like, to press the substrate 110 against the template 1. The light source 104 irradiates the substrate 110 with the UV light through the template 1.

A processed firm 111 and an imprint material 112 applied onto the processed firm 111 are formed on the substrate 110. For example, the processed firm 111 includes a semiconductor film, an insulating film, or a metallic film.

The imprint apparatus 100 includes a main controller 121 that controls drive of the light source 104 while controlling the pressurizing stage 103 through an imprint counter 120 and a display 122 such as a liquid crystal display.

The imprint counter 120 counts the number of operating times of the pressurizing stage 103 based on an operating instruction signal from the main controller 121 to the pressurizing stage 103 and outputs a count value to the main controller 121.

The pressurizing stage 103 includes a mechanism that vertically moves the substrate 110 by a hydraulic pressure, a pneumatic pressure, a motor, and the like. The pressurizing stage 103 vertically moves the substrate 110 based on an operating instruction signal from the main controller 121.

The main controller 121 includes a CPU 121a and a storage 121b, comprising a semiconductor memory and the like, in which a program and a reference value of the number of imprint times are stored. The CPU 121a controls the pressurizing stage 110 and the light source 104 to controls the imprint according to the program stored in the storage 121b. When the number of imprint times received from the imprint counter 120 reaches the reference value stored in the storage 121b, the CPU 121a displays that the number of imprint times reaches the reference value and the number of imprint times on the display 122. Examples of a setting unit of the reference value of the number of imprint times include the number of shot times, the number of processed wafers, and the number of processed lots.

### (Operation of Imprint Apparatus)

A schematic operation of the imprint apparatus 100 will now be described below. When the substrate 110 is conveyed to the imprint apparatus 100, the main controller 121 controls the imprint as follows.

The main controller 121 provides the operating instruction signal to elevate the substrate 110 to the pressurizing stage 103 through the imprint counter 120. In response to the operating instruction signal, the pressurizing stage 103 elevates the substrate 110 to press the imprint material 112 against the template 1. The concave-convex pattern 3 of the template 1 is filled with the imprint material 112.

Then, the main controller 121 drives the light source 104 to irradiate the imprint material 112 with the UV light through the template 1. The imprint material 112 is irradiated with the UV light and cured.

Then, the main controller 121 provides the operating instruction signal to lower the substrate 110 to the pressurizing stage 103. In response to the operating instruction signal, the pressurizing stage 103 lowers the substrate 110. The template 1 is separated from the imprint material 112 by lowering the substrate 110.

When the number of imprint times with respect to the identical template 1 reaches the reference value stored in the storage 121b, an indication that the number of imprint times reaches the reference value and the number of imprint times are displayed on the display 122.

When the number of imprint times reaches the previously-set reference value, the template 1 is conveyed to the template repair apparatus 10 and repaired as described in the first to fourth embodiments. After the template 1 is repaired, the template 1 is conveyed to the imprint apparatus 100 and used in the imprint again.

In the fifth embodiment, the template 1 is repaired when the count value (the number of imprint times) of the imprint counter reaches the reference value. Alternatively, the template 1 may be repaired when a count value (processing time) of a processing time accumulation counter reaches a certain reference value.

### [Modification of Fifth Embodiment]

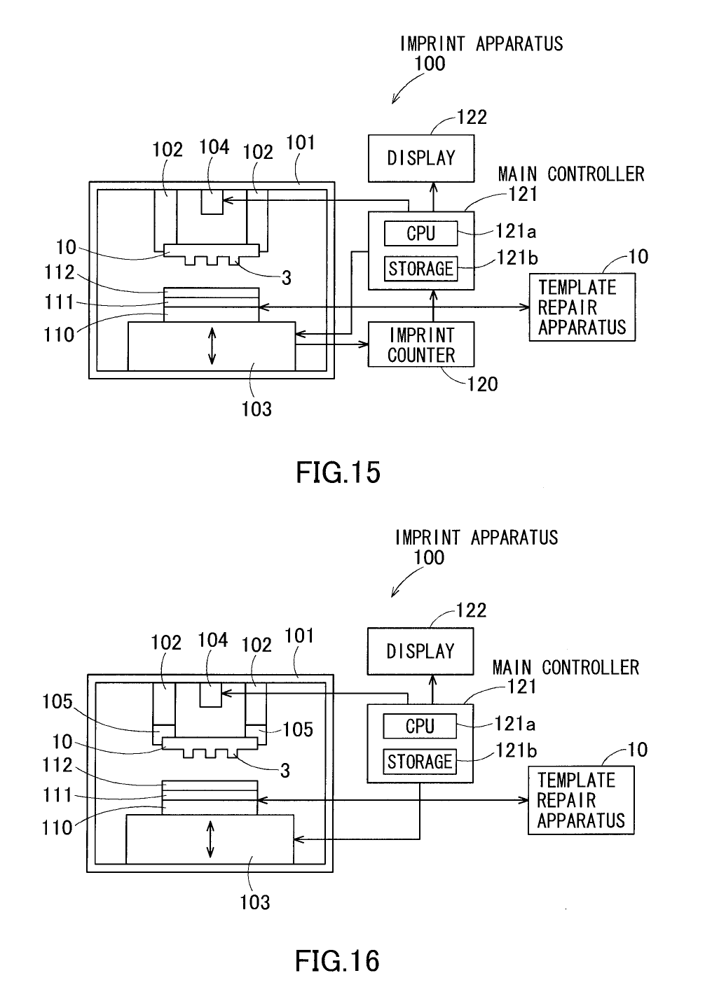

FIG. 15 is a block diagram illustrating an example of a schematic configuration of an imprint apparatus according to a modification of the fifth embodiment.

The modification shown in FIG. 15 differs from the fifth embodiment shown in FIG. 14 in that the imprint apparatus 100 controls the pressurizing stage 103 without the imprint counter 120 and the imprint counter 120 monitors the operation of the pressurizing stage 103 to count the number of operating times.

In the imprint apparatus of the modification shown in FIG. 15, an alarm is issued when the number of imprint times with respect to the identical template 1 reaches the reference value stored in the storage 121b.

When the number of imprint times reaches the previously-set reference value, the corresponding template 1 is conveyed to the template repair apparatus 10 and repaired as described in the first to fourth embodiments. After the template 1 is repaired, the template 1 is conveyed to the imprint apparatus 100 to reset the number of imprint times for the template 1 to zero, and subsequently, the template 1 is used in the imprint again.

In the apparatus in which the process is performed by elevating and lowering the template 1, preferably the imprint counter 120 counts the number of elevating and lowering times of the template 1.

### Sixth Embodiment

FIG. 16 is a block diagram illustrating an example of a schematic configuration of an imprint apparatus according to a sixth embodiment of the present invention.

In the sixth embodiment, a load cell is added in place of the imprint counter of the fifth embodiment. Hereinafter, the constituent having the function similar to that of the fifth embodiment is designated by the identical reference numeral, and the description will not be repeated.

The imprint apparatus 100 of the sixth embodiment includes the template repair apparatus 10 of the first, second, third, or fourth embodiment. Similarly to the fifth embodiment, the imprint apparatus 100 includes the chamber 101, the retaining member 102, the pressurizing stage 103, the light source 104, the main controller 121, and the display 122. In the imprint apparatus 100 of the sixth embodiment, a load cell 105 is provided between the template 1 and the retaining member 102.

When the substrate 110 is elevated by the pressurizing stage 103 to transfer the concave-convex pattern 3 of the template 1 to the imprint material 112, the load cell 105 detects a pressure to output a detection signal based on the pressure to the main controller 121.

The main controller 121 includes the CPU 121a and the storage 121b, comprising the semiconductor memory and the like, in which the program and a pressure allowable range are stored. The CPU 121a controls the pressurizing stage 110 and the light source 104 to control the imprint according to the program stored in the storage 121b. When the pressure indicated by the detection signal from the load cell 105 is an abnormal pressure out of the pressure allowable range stored in the storage 121b, the CPU 121a displays that the pressure is the abnormal pressure and the pressure value on the display 122

When the pressure in the imprint is determined to be the abnormal pressure, the template 1 is conveyed to the template repair apparatus 10 and repaired as described in the first to fourth embodiments. After the template 1 is repaired, the template 1 is conveyed to the imprint apparatus 100 and used in the imprint again.

### (Effects of Embodiments)

According to the embodiments described above, the defective portion of the base material is repaired by the material that has the affinity to the base material and has the non-affinity to the mold release layer, so that the defective portion of the base material in which the mold release layer is formed on the surface thereof can selectively be repaired. As described in the second to fourth embodiments, the repair process may be performed at the same time as the process of forming the mold release layer on the whole surface of the concave-convex pattern 3 of the template 1 again. In the template repair methods of the first to fourth embodiments, the micro defective portion that cannot be found through the template inspection process can selectively be repaired. Accordingly, similarly to the process of forming the mold release layer again, the template repair method may be set so as to be periodically performed at a predetermined timing.

### (Modifications)

In the embodiments described above, the base material is made of the quartz. However, the base material is not limited to the quartz, but another material may be used as the base material. For example, when the base material is made of oxides (such as glass, Pyrex glass, alumina, sapphire, metallic oxides such as a chromium oxide, a molybdenum oxide, a titanium oxide, a ruthenium oxide, and a yttrium oxide, and nitrides thereof), the repair can be performed using the liquid glass such as the silicon oxide supersaturated solution of the hydrofluoric acid similarly to the embodiments.

When the template is used in thermal imprint while the base material is made of Ni (nickel), Ni is deposited in a Ni defective portion by performing Ni electroforming in the Ni defective portion. After a proper amount of Ni is deposited, the repair may be performed by selectively forming the mold release material with respect to the Ni with which the defective portion is filled. When Ni is also deposited on the mold release layer surface, the mold release layer is peeled off after the Ni electroforming, and the mold release layer may newly be formed.

Any material can be used as the material for repairing the defective portion of the base material as long as the material reacts with not the mold release layer but the base material and satisfies strength required for the repair area and an optical transmittance.

It is not necessary that the material for repairing the defective portion of the mold release layer be identical to the mold release layer formed on the base material, as far as the material for repairing the defective portion of the mold release layer have a reactive property with respect to the surface after being repaired and mold release performance is substantially identical to that of the mold release layer formed on the base material.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A method of repairing a template including a base material and a first mold release layer formed on a pattern surface of the base material, the method comprising supplying a restorative material that has affinity to the base material and has non-affinity to the first mold release layer to the pattern surface.

2. The method according to claim 1, wherein a second mold release layer is formed on a surface of the restorative material that has the affinity to the base material and has the non-affinity to the first mold release layer after the material is supplied to the pattern surface.

3. The method according to claim 2, wherein, after the restorative material that has the affinity to the base material and has the non-affinity to the first mold release layer is supplied, the first mold release layer is removed, and the second mold release layer is formed on the pattern surface and the surface of the material supplied to the pattern surface.

4. The method according to claim 1, wherein a foreign substance having adhered to the pattern surface is removed before the restorative material that has the affinity to the base material and has the non-affinity to the first mold release layer is supplied.

5. The method according to claim 2, wherein a foreign substance having adhered to the pattern surface is removed before the restorative material that has the affinity to the base material and has the non-affinity to the first mold release layer is supplied.

6. The method according to claim 3, wherein a foreign substance having adhered to the pattern surface is removed before the restorative material that has the affinity to the base material and has the non-affinity to the first mold release layer is supplied.

7. The method according to claim 1, wherein a corrosive substance that has a corrosive property to the base material is supplied to the pattern surface before the restorative material that has the affinity to the base material and has the non-affinity to the first mold release layer is supplied.

8. The method according to claim 2, wherein a corrosive substance that has a corrosive property to the base material is supplied to the pattern surface before the restorative material that has the affinity to the base material and has the non-affinity to the first mold release layer is supplied.

9. The method according to claim 3, wherein a corrosive substance that has a corrosive property to the base material is supplied to the pattern surface before the restorative material that has the affinity to the base material and has the non-affinity to the first mold release layer is supplied.

10. A pattern forming method for performing imprint to an imprint material on a substrate using the template repaired by the template repair method according to claim 1.

11. A template repair apparatus that repairs a template including a base material and a first mold release layer formed on a pattern surface of the base material, comprising a repair unit that supplies a restorative material that has affinity to the base material and has non-affinity to the first mold release layer is supplied to the pattern surface.

12. The template repair apparatus according to claim 11, further comprising a mold release layer forming unit that forms a second mold release layer on a surface of the material supplied to the pattern surface.

13. The template repair apparatus according to claim 11, further comprising a mold release layer removing unit that removes the first mold release layer.

14. The template repair apparatus according to claim 12, further comprising a mold release layer removing unit that removes the first mold release layer.

15. The template repair apparatus according to claim 11, further comprising a foreign substance removing unit that removes a foreign substance having adhered to the pattern surface.
